(19) United States
(12) Patent Application Publication
(10) Pub. No.: US 2014/0234125 A1
(43) Pub. Date: Aug. 21, 2014

(54) SYRINGELESS FILTER DEVICE COMPRESSOR

(71) Applicant: GE HEALTHCARE UK LIMITED, LITTLE CHALFONT (GB)

(72) Inventors: David Gwyn Treharne, Newport (GB); Geraint Seymour, Cardiff (GB); Navin Deepal Pathirana, Piscataway, NJ (US); Christopher Burrows, Cardiff (GB); Neil John Williams, Cardiff (GB); Aidan PAUL Vaughan, Cardiff (GB); Robert William Richardson, Cardiff (GB)

(21) Appl. No.: 14/346,850

(22) PCT Filed: Sep. 26, 2012
(86) PCT No.: PCT/EP2012/068918

§ 371 Date: Mar. 24, 2014

(30) Foreign Application Priority Data
Sep. 30, 2011 (GB) 1116905.9
Jun. 13, 2012 (GB) 1210448.5

(51) Int. Cl. B01L 3/02; F04B 43/00

(52) U.S. Cl. CPC B01L 3/02; F04B 43/00
USPC 417/53; 417/437

(57) ABSTRACT

The disclosure relates to an in-hand operable compressor 200 for compressing syringeless filter devices 100. The compressor 200 includes a base 220 having a receiving well 222 adapted to receive a bottom portion of the uncompressed device 100, and a discrete top 210 having a receiving recess (212 FIG. 4) adapted to receive a top portion of the uncompressed device 100, said base and top being brought together in use by hand compression to cause compression of the device 100 located in the well and recess of the compressor. Surface formations 250 and 252 (FIG. 2) are complementary and inhibit misalignment of said well and recess during the in-hand compression.

### FIELD OF THE INVENTION

The present invention relates to a manually operable compressor for compressing syringeless filter devices used in filtering laboratory sample liquids.

### BACKGROUND OF THE INVENTION

Filtration devices are frequently employed in laboratory and other environments to remove solids or particulates from a liquid sample. Liquid samples, for example, filtration of a pharmaceutical drug (that has been dissolved in a suitable solvent) to remove insoluble excipients prior to quantitative analysis of the active pharmaceutical ingredient(s). The filtrate may then be used to perform laboratory tests, such as high-performance liquid chromatography (HPLC) analysis.

Some laboratory filtration devices, typically referred to as “syringe filters”, require a standard laboratory syringe, into which a liquid sample to be filtered is drawn. A syringe filter is then fitted to the tip of the syringe and the syringe plunger is compressed, forcing the liquid sample contained within the syringe through the syringe filter into a separate receptacle. However, use of syringe filters according to the above procedure can be time consuming, and due to the number of components required, can be relatively costly.

Alternative laboratory filtration devices, referred to as “syringeless filters”, in which no syringe is used have been developed, such as the commercially available Whatman™ Mini-Uniprep™. FIG. 1 shows an exemplary syringeless filter device 100, in assembled form. The device 100 comprises a vial 102 (typically having a capacity of approximately 0.4 ml) for holding a liquid sample to be filtered. The device 100 also comprises a hollow plunger 106 having a filtration membrane at one end, and a pre-attached cap 110 at the other end. During filtration, the device 100 is compressed so that the plunger 106 slides towards the bottom of the vial 102; as the plunger 106 slides, a seal on the exterior walls of the plunger 106 engages with the internal walls of the vial 102, preventing the liquid sample 104 from passing around the outside of the plunger 106. Accordingly, the liquid sample is forced through the filtration membrane, and into the interior of the plunger 106 where it collects as a filtrate, leaving filtered particles in the bottom of the vial 102. The filtrate can then be stored or transported in this state for extended periods (typically up to several days) until it is needed, at which time it may be removed from the plunger by, for example, using a syringe needle to pierce a septum 120 in the cap 110.

Whilst the term “syringeless filter device” is used herein, an equivalent term often used is “filter vial”, as in the case of the Thomson SINGLE StEP™ Filter Vial device; such devices perform the same function as the syringeless filter device described above and may be operated in the same way.

Syringeless filter devices such as those described above are simpler to use than syringe filters.

The step of compressing the syringeless filter device may be performed manually, with a human operator pressing the plunger into the vial using their hand. However, this may be time consuming, and can be uncomfortable for the operator, since the force required to push the plunger into the vial may be significant, due to the resulting back-pressure from the filtering described above. Further, the compression process can result in breakage of the syringeless filter device where too much compression force is used, especially where glass components are used. This poses a risk of injury to the operator, as well as potentially bringing him or her into contact with the sample to be filtered; in particular, where the sample is held in a potentially harmful solvent such as acetonitrile or methanol, such contact is undesirable.

The Whatman™ Six Position Compressor™ is a device for compressing multiple syringeless filter devices in a single action. The device comprises a base fixed to a hand lever via a pivot. The base includes six shallow recesses, arranged in a straight line, for locating syringeless filter devices for compression. In use, the hand lever is raised to allow an operator to individually locate each of the uncompressed syringeless filter devices in the recesses. The operator then brings down the hand lever to a horizontal position in a swinging motion about the pivot. Consequently, the lever pushes downwards onto each of the syringeless filter devices, and compresses them, in turn. Although this compressor is satisfactorily for existing products, the introduction of glass chambers in syringeless filters has meant that a purely vertical compressive force is desirable so that the glass chambers are not subjected to side loads. Also, a simpler and cheaper device is desirable for smaller numbers of compressions.

In embodiments, the present invention address the problems mentioned above by providing a simple in-hand operable syringeless filter compressor device.

### SUMMARY OF THE INVENTION

In accordance with a first aspect of the present invention, there is provided a hand operated compressor suitable for compressing a syringeless filter device in use, said compressor including a base having a receiving well adapted to receive a bottom portion of the uncompressed device, and a top having a receiving recess adapted to receive a top portion of the uncompressed device, said base and top being relatively moveable to allow compression of the device located in the well and recess of the compressor, the base and top including also complementary formations inhibiting misalignment of said well and recess.

Thereby, misalignment of the compressor base and top is reduced or eliminated because the base and top can be brought together in a generally aligned manner.

In an embodiment, the well and recess each have an axis, coinciding generally with the direction of said movement, and said complementary formations include surfaces extending generally radially away from the well and recess axes respectively.

Thereby, said surfaces may abut in use to prevent relative tilting of the base and the top, and hence keep the device parts aligned during compression movement to provide the inhibition of misalignment.

Preferably, the surfaces extend substantially perpendicularly to said axis.

More preferably, the base or top includes a substantially axially extending collar such that there is no clear radial linear path between the axis and any point external to the compressor at least during said latter third of the compression movement.

In an embodiment, the base and top have further complementary formations, which are alignable by relative axially rotation of the base and top to allow a final compression movement of the base and top.

Preferably said final compression movement is approximately 1 mm

In this way, the device can only be completely compressed with full alignment of the base and top, and so misalignment is not possible.

Preferably, the compressor comprises at least a portion of a transparent or translucent material whereby at least a part of the well is visible externally.

Preferably, the compressor comprises a channel extending from the well to the external wall, and the transparent or translucent material is a discrete part located in a groove formed in opposing sides of the channel.

Preferably, compressor has a substantially circular section perpendicular to the axis and preferably the compressor is substantially barrel shaped, when the base and top are brought together.

Thereby, the compressor is comfortable in the hand of a user.

Preferably, the base and top are discrete pieces, preferably formed from substantially separate mouldings, for example, plastics mouldings.

In accordance with a second aspect of the invention, there is provided a method for compressing a syringeless filter device by hand, including the step of: providing a syringeless filter device, containing a liquid sample to be filtered; providing a compressor having a base and a top which are relatively moveable, the base including a well and the top including a recess; manually inserting the device into a well and into the recess; and by in-hand movements, bringing together a top and a base of a compressor, thereby compressing the device and filtering said liquid sample during said movement; the base and top each having complementary formations for inhibiting their misalignment during said in-hand movements.

In accordance with a third aspect of the invention there is provided, a syringeless filter device when used with the compressor of the first aspect, or when used in the method of the second aspect.

### BRIEF DESCRIPTION OF THE DRAWINGS

Although, aspects of the invention have been set out above, the invention can be put into effect in numerous ways, one example only of which is described below with reference to the drawings, wherein:

FIG. 1 is pictorial view of an exemplary compressor for a syringeless filter device and a syringeless filter device shown also in this Figure;

FIG. 2 is a side view of the compressor in the direction of arrow II in FIG. 1, with the syringeless filter device inserted within the compressor;

FIG. 3 is a pictorial side view of the now substantially compressed compressor, viewed in the direction of arrow III in FIG. 1;

FIG. 4 is a sectional pictorial view of the compressor and device in the substantially compressed state; and

FIGS. 5 and 6 are pictorial views of two different further examples of a compressor device.

### DETAILED DESCRIPTION OF THE INVENTION

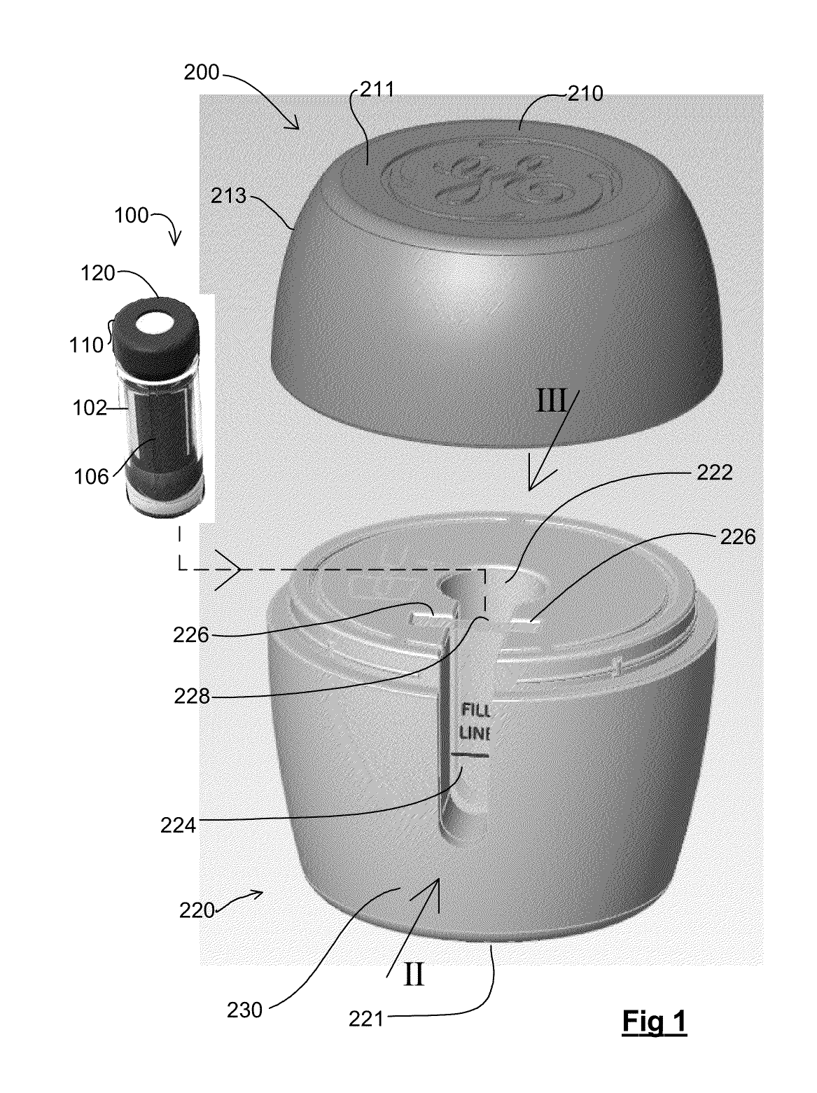

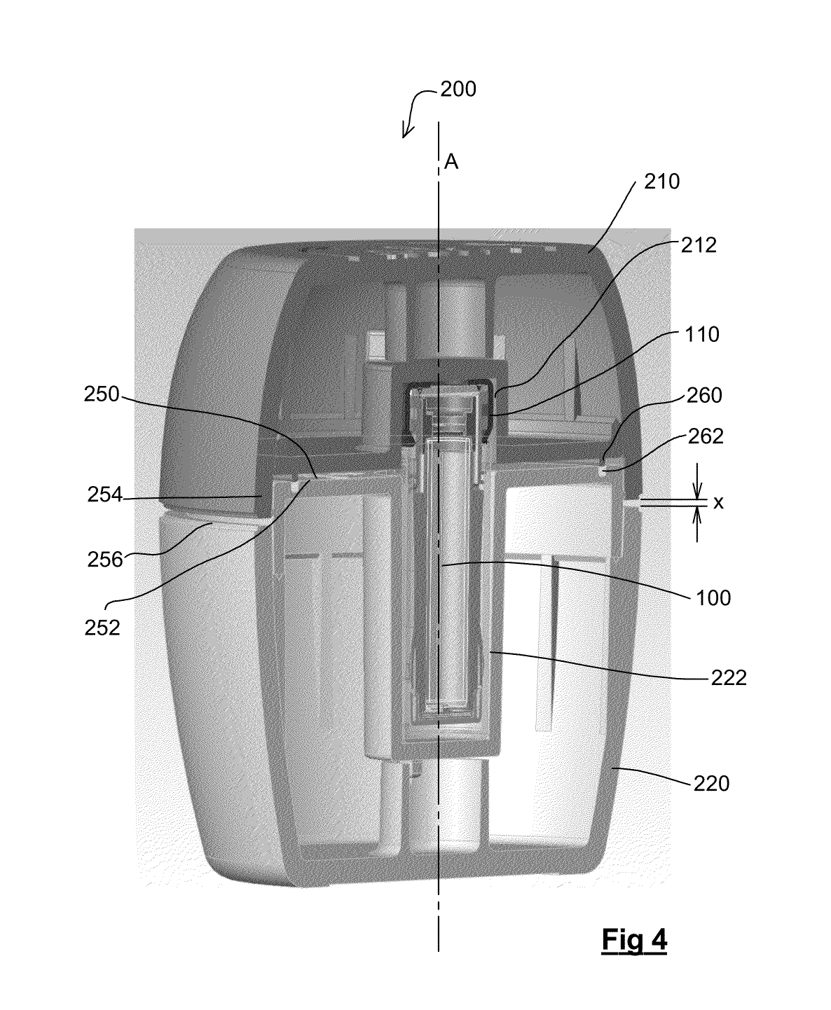

FIG. 1 shows a known syringeless filter device 100, which is also referred to as a filter vial, as previously described. FIG. 1 shows also a novel syringeless filter device compressor 200, which comprises a base 220 and a separate top 210. The filter 100 is placed into a well 222 in the base and the top is brought down onto the cap 110 of the device 100 to compress it. The cap 110 sits in a recess 212 (shown in FIG. 4) in the underside of the top 210 . In use the top and base are held in a user's hand and are shaped and sized such that the compressor fits comfortably in one hand during the compression. The compressor is barrel shaped, in this case with generally flat ends 211 and 221 and curved cylindrical sides 213 and 230. By experimentation, it has been found that this is a comfortable shape for in-hand compression. The compressor can also be used on a bench or worktop, by pressing the top onto the base , as the base sits on the bench or worktop. In each case the compressor is operated by hand.

In FIG. 1 a window 224 is visible, which is formed from transparent plastics sheet material held within grooves 226, formed in the sides of a viewing channel 228 which in turn extends from the well 222 to an external wall 230 of the compressor base 220. The window allows the operator to visually inspect the progress of the compression movement.

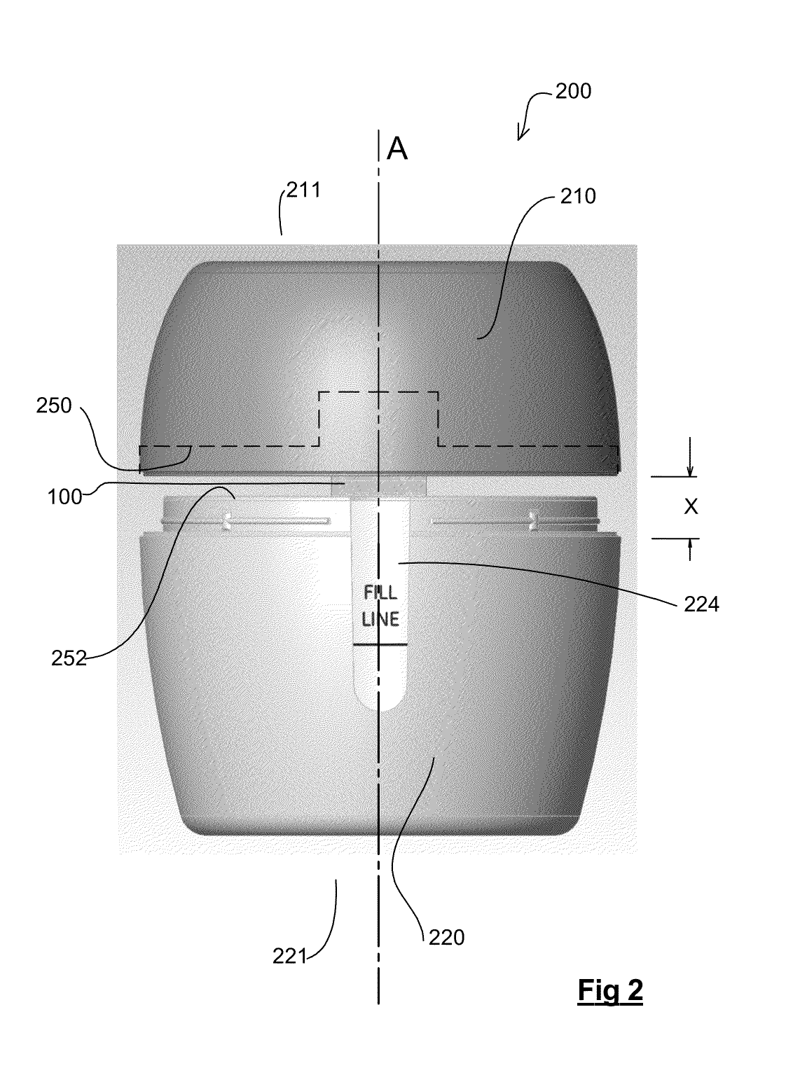

FIG. 2 shows a side view of the compressor 200 with the device 100 awaiting compression generally along an axis A. Compression is accomplished by relative manual movement of the base 220 and top 210 together by a distance X of around 10 to 20 mm along axis A. Here, it can be observed that the compressor 200 has formations 250 and 252, described in more detail below, which will prevent substantial misalignment of the base and top about axis A, during compression of the device 100 at least during the latter part of the compression, and increasingly so, as compression progresses.

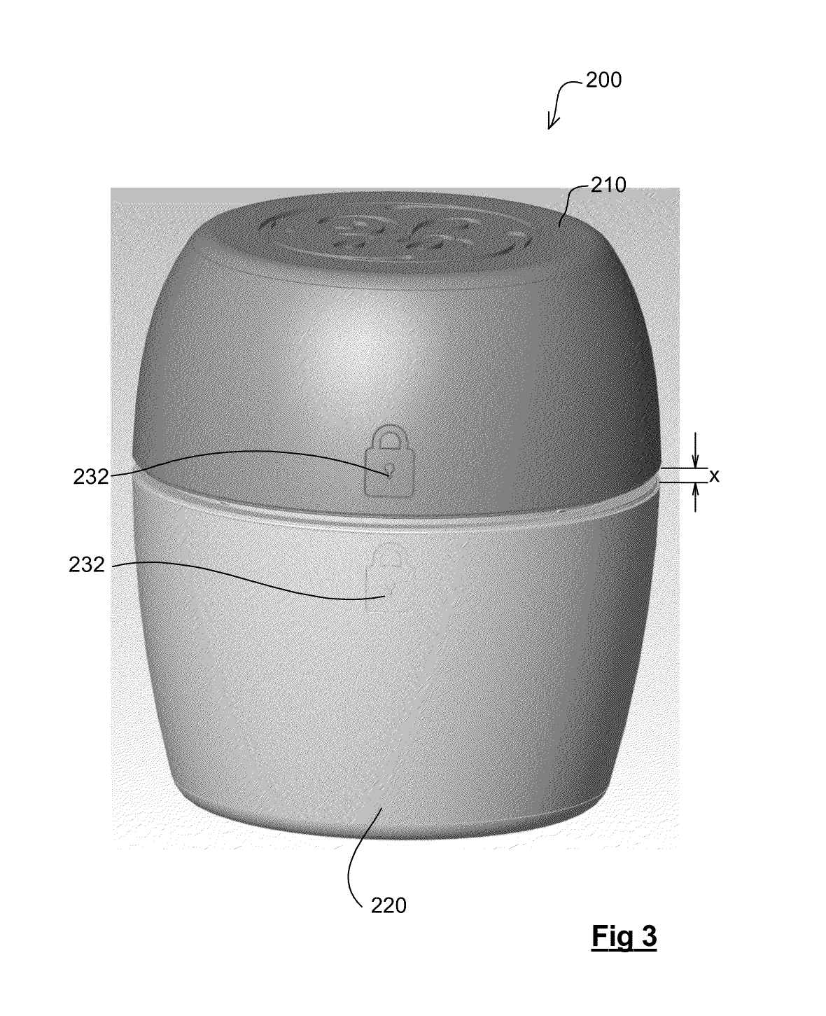

FIG. 3 shows the compressor 200 now substantially compressed. Indicia 232, formed on the top 210 and base 220 show the correct alignment of these parts to complete the compression step which is accomplished by said alignment, and further compression by a distance x, which is about 1 mm.

FIG. 4 is a sectional view corresponding to FIG. 3. In this view the substantially compressed device 100 is visible within the compressor 200 awaiting a final compression by the distance x. The formations 250 and 252 are shown, which in this embodiment, are generally flat surfaces extending radially away from the axis A. Thus the top 210 and base 220 cannot tilt excessively with respect to the device 100, and as compression progresses, the amount of tilting possible decreases because the surfaces 250 and 252 come closer together.

In addition, a collar 254 extends from the outer periphery of the surface 250, and extends in a generally axial direction. The collar 254 is complemented by an annular groove 256, which receives the collar during compression. The collar and annular groove also act as complementary formations to inhibit misalignment. Further, the collar 252 acts to shield a user from the device 100 during the latter stages of compression, because the collar extends to obscure the device 100, and so any bursting parts of the device 100 will not travel directly toward a user's hands.

Further formations 260 and 262 in the top and base respectively, act to prevent final compression, until they are aligned about the axis A. Twisting of the top relative to the base brings the formations 260 and 262 into alignment, and the last x distance of compression can be completed. In this embodiment, the formation 260 is an incomplete annular protrusion, and the formation 262 is a generally equally incomplete annular groove. Until the protrusion 260 and groove 262 are aligned the protrusion 260 cannot fall into the groove 262. Thus the user cannot complete the compression quickly, without aligning the top and base accurately, and the user cannot fully compress the device 100 suddenly.

The dimensions of the syringeless filtration device compressor 200 are typically selected dependent on the syringeless filtration device 100 with which the syringeless filter device compressor 200 is to be used. In the case of Whatman™ Mini-Uniprep™ syringeless filters, the compression distance X (see FIG. 1) is around 10 to 20 mm; the internal diameter of a well 222 and recess 212 is approximately 12 mm. The overall height of the compressor is around 50-60 mm when compressed and has a diameter of around 50 mm at its widest point.

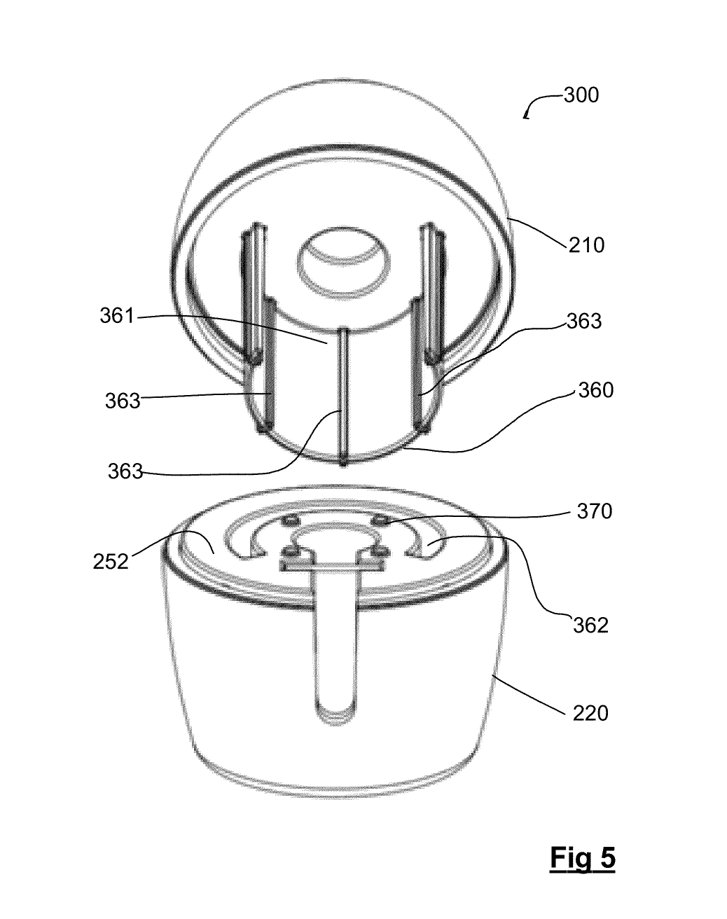

A second version 300 of a compressor is shown in FIG. 5, where parts common to the compressor 200 have like reference numerals. In this version, the formations 260 and 262 are replaced with far more pronounced formations 360 and 362, but which serve the same purpose, which is to align the top 210 and base 220 during compression. Formation 360 is a part-annular (an incomplete annulus) sleeve which extends around the axis of the compressor and has an opening 361 to accommodate the observation window 224. Formation 262 is a complementary part-annular channel extending downwardly from the top face 252 of the base 220. The sleeve 360 and the channel 362 are dimensioned such that the sleeve engages the channel prior to any initial compression of the syringeless filtration device 100. Strengthening ribs 363 spaced around the sleeve 360 and running axially along the sleeve add rigidity to the sleeve to inhibit bending in use, and also increase the effective width of the sleeve to fit more snugly in the channel 362 as the sleeve slides axially in the channel in use, without requiring excess use of plastics material. As with the collar 260, the sleeve 360 generally blocks the path for any debris if a filter device were to shatter.

This second embodiment also includes four dimples 270, only one of which is referenced, which act as final stops to prevent over compression of the filter device, and also act as final alignment members.

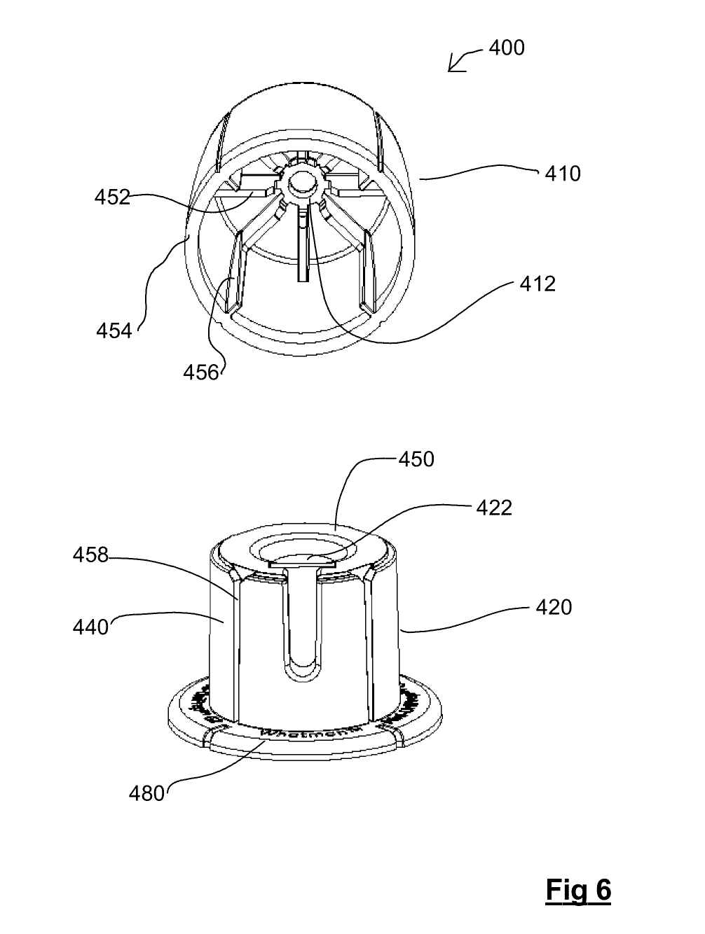

FIG. 6 shows a third embodiment of a compressor 400 which has the same function as the first and second embodiments. The compressor 400 has a base 420, including a well 422 into which a syringless filter 100 can be partially inserted, and a top 410, including a recess 412 which locates over the top of the filter 100, and is used to manually compress the filter, in the manner described above.

In this embodiment the top 410 has a skirt 454, which extends externally over sides 440 of the base 420. The skirt includes four webs 456 which slide within complementary channels 458 in the sides of the base, to provide additional location. The skirt 454, webs 456, sides 440 and channels 458 are complementary formations which provide alignment of the top and base when compression takes place, thus inhibiting misalignment.

When the top and base come closer together radially extending portions 452 of the webs 456 abut with an upper face 450 of the base to provide final alignment of the top and base.

This embodiment is intended for use on a bench, whereby a user pushes down on the top 410 to compress a filter 100, whilst the base 420 rests on the bench. The base 420 also includes a lower flange 480, which provides a stability when a filter 100 is compressed on the bench.

The above embodiments are illustrative of the invention and it will be understood that the invention is not limited to those embodiments. For example the term ‘base’ and lop', as well as various expressions which define orientation of the device 100 and compressor 200 are not intended to limit use of those elements in any particular orientation, but are merely representative of the orientation shown in the drawings.

The term ‘syringeless filter’ is not limited to the device shown in FIG. 1, and other similar devices are envisaged for use with the invention. For example, also included in the definition of a syringeless filter device is a device in which the filtrate is collected externally. For example, syringeless filter devices such as the Whatman™ Autovial™ may be used. The Whatman™ Autovial™ comprises a plunger and a barrel, with the liquid sample to be filtered being initially held in the barrel. The barrel has an opening at one end through which liquid may pass via a filter membrane; during filtering, the plunger is pushed towards the filter membrane, forcing the liquid sample through the filter membrane and through the opening; the filtrate exiting the device is collected in an autosampler vial or any other appropriate container. In embodiments in which externally-collecting syringeless filtration devices are used, the containers for collecting the filtrate could be located in the holder 206, so that a syringeless filter device engages with each of the containers.

It is to be understood that any feature described in relation to any one embodiment may be used alone, or in combination with other features described, and may also be used in combination with one or more features. Furthermore, equivalents and modifications not described above may also be employed without departing from the scope of the invention, which is defined in the accompanying claims.

1. A hand operable compressor suitable for compressing a syringeless filter device in use, said compressor including a base having a receiving well adapted to receive a bottom portion of the uncompressed device, and a top having a receiving recess adapted to receive a top portion of the uncompressed device, said base and top being relatively moveable to allow compression of the device located in the well and recess of the compressor, the base and top including also complementary formations inhibiting misalignment of said well and recess.

2. The compressor of claim 1, wherein the well and recess each have an axis, coinciding generally with the direction of said movement, and said complementary formations include surfaces extending generally radially away from the well and recess axes respectively.

3. The compressor of claim 2, wherein said surfaces extend substantially perpendicularly to said axes.

4. The compressor of claim 1, wherein the base or top includes a substantially axially extending collar, sleeve, or skirt, such that there is no clear generally radial linear path between the axis and any point external to the compressor at least during said latter third of the compression movement.

5. The compressor of claim 1, wherein the base and top have further complementary formations, which are alignable by relative axial rotation of the base and top to allow a final compression movement of the base and top.

6. A-The compressor as claimed in of claim 5, wherein said final compression movement is approximately 1 mm.

7. The compressor of claim 1, wherein the base and top include further complementary formations which provide alignment of the base and top prior to said compression.

8. The compressor of claim 7, wherein said further complementary formations include a part- annular sleeve and a complementary channel formed in the base such that the sleeve may slide axially in the channel and provide said alignment.

9. The compressor of claim 1, further comprising at least a portion of a transparent or translucent material whereby at least a part of the well is visible externally.

10. The compressor of claim 9, further comprising, a channel extending from the well to an external wall of the base, and the transparent or translucent material is a discrete part located in a groove formed in opposing sides of the channel.

11. The compressor of claim 1, wherein the compressor is substantially barrel shaped, when the base and top are brought together.

12. The compressor of claim 1, wherein the base and top are discrete pieces, preferably formed from substantially separate mouldings, for example, plastics mouldings.

13. The compressor of claim 1, wherein the base includes a flange located distal from the well and extending outwardly from the base.

14. The compressor of claim 1, wherein the top includes a skirt extending around the base in use and engaeable with the base prior to compression.

15. A method for compressing a syringeless filter device by hand, including the step of:
providing a syringeless filter device, containing a liquid sample to be filtered;
providing a compressor having a base and a top which are relatively moveable, the base including a well and the top including a recess;
manually inserting the device into a well and into the recess; and
bringing together a top and a base of a compressor by hand movements, thereby compressing the device and filtering said liquid sample during said movement;
wherein the base and top each having complementary formations for inhibiting their misalignment during said hand movements.
